(19) United States
(12) Patent Application Publication
(10) Pub. No.: US 2025/0209231 A1
(43) Pub. Date: Jun. 26, 2025

(54) METHODS AND SYSTEMS FOR GENERATING DIGITAL PIPING DATA FROM A PAPER ISOMETRIC IMAGE

(71) Applicants: Mohan Kingam, Hyderabad (IN); Vikas Lalith Apuroop Sagi, Hyderabad (IN)

(72) Inventors: Mohan Kingam, Hyderabad (IN); Vikas Lalith Apuroop Sagi, Hyderabad (IN)

(21) Appl. No.: 18/974,596

(22) Filed: Dec. 9, 2024

(30) Foreign Application Priority Data
Dec. 21, 2023 (IN) 202341087755

(51) Int. Cl. G06F 30/18; G06T 11/40

(52) U.S. Cl. CPC G06F 30/18; G06T 11/40

(57) ABSTRACT

A method of generating digital piping data from a paper isometric image. The method includes receiving a 2-Dimensional (2D) isometric image corresponding to a piping structure. The 2D isometric image comprises one or more piping components corresponding to the piping structure. The method also includes identifying at least one a direction, an orientation, a name, and dimensions of each of the piping components in a 3D space. The method further includes identifying 3D coordinate information corresponding to a start point and an end point of each of the piping components. Furthermore, the method includes generating 3D geometry configuration data corresponding to each of the piping components based on the corresponding identified 3D coordinate information, and the corresponding at least one of the direction, an orientation, and a dimension in a predefined standard format.

### CROSS-REFERENCE TO RELATED APPLICATION(S)

This patent application claims priority from India Patent Application No. 202341087755 entitled METHODS AND SYSTEMS FOR GENERATING DIGITAL PIPING DATA FROM A PAPER ISOMETRIC IMAGE filed Dec. 21, 2023, which is hereby incorporated herein by reference in its entirety.

### FIELD OF THE INVENTION

The present invention generally relates to image processing and deep learning, and more specifically relates to a method and a system for generating digital piping data from paper isometric drawing images.

### BACKGROUND

Piping isometric drawings are a specific type of 2-Dimensional (2D) drawings represented in an isometric view direction and are widely used in plant design, particularly in the field of piping systems. These drawings provide a graphical representation of a piping system, illustrating various components like pipes, fittings, valves, and other components arranged in a space. Such drawings are a crucial part of the planning, design, and construction of industrial facilities, such as chemical plants, refineries, power plants, and other installations where complex piping systems are required.

A typical brown field project, e.g., an industrial plant that is already in operation, maintains thousands of piping isometric drawings in conventional Computer-Aided Design (CAD) or Portable Document Format (PDF) formats. Generally, such drawings are referred to as paper isometrics. These conventional formats of the isometric drawings include non-intelligent graphics that cannot be transformed or rendered in any 3-Dimensional (3D) modelling application. Furthermore, such isometric drawings are often inconsistent in quality, are unfit for change/version management, and are prone to errors when used for plant planning, design and construction.

Moreover, a typical brown field project comprises of thousands of paper isometrics, thus manual conversion of each drawing into a digital format makes the whole digitalization process time-consuming and expensive.

Thus, there is a need to provide a solution to overcome the above challenges associated with piping isometric drawings.

### SUMMARY

This summary is provided to introduce a selection of concepts in a simplified format that is further described in the detailed description of the inventive concepts. This summary is not intended to identify key or essential inventive concepts, nor is it intended for determining the scope of the inventive concepts.

According to embodiments of the present disclosure, a method of generating digital piping data from a paper isometric image is disclosed. The method includes receiving a 2-Dimensional (2D) isometric image corresponding to a piping structure. The 2D isometric image comprises one or more piping components corresponding to the piping structure. Further, the 2D isometric image comprises a plurality of arrow components and corresponding text data related to the one or more piping components. The method also includes identifying at least one a direction, an orientation, a name, and dimensions of each of the one or more piping components of the piping structure, in a 3-Dimensional (3D) space based on the plurality of arrow components and corresponding text data included in the 2D isometric image. Moreover, the method includes identifying 3D coordinate information corresponding to a start point and an end point of each of the one or more piping components based on the identified corresponding at least one of the direction, the orientation, the name, and the dimensions. Furthermore, the method includes generating 3D geometry configuration data corresponding to each of the one or more components of the piping structure based on the corresponding identified 3D coordinate information, and the corresponding at least one of the direction, the orientation, and the dimension in a predefined standard format.

According to embodiments of the present disclosure, a system of generating digital piping data from a paper isometric image is disclosed. The system includes a memory and at least one processor communicably coupled with the memory. The at least one processor is configured to receive a 2-Dimensional (2D) isometric image corresponding to a piping structure. The 2D isometric image comprises one or more piping components corresponding to the piping structure. Further, the 2D isometric image comprises a plurality of arrow components and corresponding text data related to the one or more piping components. The at least one processor is also configured to identify at least one a direction, an orientation, a name, and dimensions of each of the one or more piping components of the piping structure, in a 3-Dimensional (3D) space based on the plurality of arrow components and corresponding text data included in the 2D isometric image. The at least one processor is further configured to identify 3D coordinate information corresponding to a start point and an end point of each of the one or more piping components based on the identified corresponding at least one of the direction, the orientation, the name, and the dimensions. Moreover, the at least one processor is configured to generate 3D geometry configuration data corresponding to each of the one or more components of the piping structure based on the corresponding identified 3D coordinate information, and the corresponding at least one of the direction, the orientation, and the dimension in a predefined standard format.

According to embodiments of the present disclosure, a non-transitory computer-readable medium having stored thereon computer-executable instructions is disclosed. The computer-executable instructions, when executed by a processor of an apparatus, cause the apparatus to execute operations, the operations comprising receiving a 2-Dimensional (2D) isometric image corresponding to a piping structure, wherein the 2D isometric image comprises one or more piping components corresponding to the piping structure, and wherein the 2D isometric image comprises a plurality of arrow components and corresponding text data related to the one or more piping components. The operations also include identifying at least one of a direction, an orientation, a name, and dimensions of each of the one or more piping components of the piping structure, in a 3-Dimensional (3D) space based on the plurality of arrow components and corresponding text data included in the 2D isometric image. The operations further include identifying 3D coordinate information corresponding to a start point and an end point of each of the one or more piping components based on the identified corresponding at least one of the direction, the orientation, the name, and the dimensions. Moreover, the operations include generating 3D geometry configuration data corresponding to each of the one or more piping components of the piping structure based on the corresponding identified 3D coordinate information, and the corresponding at least one of the direction, an orientation, and a dimension in a predefined standard format.

To further clarify the advantages and features of the inventive concepts, a more particular description of the inventive concepts will be rendered by reference to specific examples thereof, which are illustrated in the appended drawings. It is appreciated that these drawings depict only embodiments of the inventive concepts and are therefore not to be considered limiting its scope. The inventive concepts will be described and explained with additional specificity and detail with the accompanying drawings.

### BRIEF DESCRIPTION OF THE DRAWINGS

These and other features, aspects, and advantages of the inventive concepts will become better understood when the following detailed description is read with reference to the accompanying drawings in which like characters represent like parts throughout the drawings, wherein:

FIG. 1 illustrates an exemplary isometric image, according to an embodiment of the present disclosure;

FIG. 2 illustrates a system for generating digital piping data from a paper isometric image, according to an embodiment of the present disclosure;

FIG. 3 illustrates a process flow depicting a method for generating the piping data from the paper isometric image, according to embodiments of the present disclosure;

FIG. 4 illustrates different types of line forms in the isometric drawing, according to an embodiment of the present disclosure;

FIG. 5 illustrates symbol identification in the isometric drawing, according to an embodiment of the present disclosure;

FIG. 6 illustrates arrowhead identification in the isometric drawing, according to an embodiment of the present disclosure;

FIG. 7 illustrates weld identification in the isometric drawing, according to an embodiment of the present disclosure;

FIG. 8 illustrates erection and fabrication data generated from a material list, according to an embodiment of the present disclosure;

FIG. 9 illustrates an exemplary Piping Component File (PCF), according to an embodiment of the present disclosure;

FIG. 10 illustrates a detailed process flow depicting a method for generating the piping data from the paper isometric image, according to embodiments of the present disclosure; and

FIG. 11 illustrates a flow chart of a method for generating the digital piping data from the paper isometric image, according to embodiments of the present disclosure.

Further, skilled artisans will appreciate that elements in the drawings are illustrated for simplicity and may not have been necessarily drawn to scale. For example, the flow charts illustrate the method in terms of prominent operations involved to help to improve understanding of aspects of the inventive concepts. Furthermore, in terms of the construction of the device, one or more components of the device may have been represented in the drawings by conventional symbols, and the drawings may show only those specific details that are pertinent to understanding embodiments of the inventive concepts so as not to obscure the drawings with details that will be readily apparent to those of ordinary skill in the art having the benefit of the description herein.

### DETAILED DESCRIPTION

It should be understood at the outset that although illustrative implementations of embodiments of the present disclosure are illustrated below, the inventive concepts may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “paper isometric image” is used herein to refer to a legacy drawing of a piping system (where a piping system may include one or more pipes and/or other components, e.g., a pipe spool) in the form of one or more 2D isometric, orthographic, section, cut-out, or other view(s) of the piping system without enhanced 3D information that allows manipulating in modern 3D piping management systems. Physically, a paper isometric image may be on paper such as a blueprint, a computer printout, a hand drawing, a photograph, or other 2D physical medium, or may be in a digital form such as a conventional Computer-Aided Design (CAD) file, a Portable Document Format (PDF) file, a digital photograph, or other 2D digital format.

The term “some” as used herein is defined as “none, or one, or more than one, or all.” Accordingly, the terms “none,” “one,” “more than one,” “more than one, but not all” or “all” would all fall under the definition of “some.” The term “embodiments” may refer to no embodiments, to one embodiment, to several embodiments, or to all embodiments. Accordingly, the term “embodiments” is defined as meaning “no embodiment, or one embodiment, or more than one embodiment, or all embodiments.”

The terminology and structure employed herein are for describing, teaching, and illuminating embodiments and their specific features and elements and do not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as, or a similar meaning to, that commonly understood by one having ordinary skill in the art.

Certain embodiments process paper isometric images (e.g., using advanced image processing and artificial intelligence techniques) to automatically transform non-intelligent 2D isometric piping system images (e.g., labels contexts, visuals, dimensions, materials, etc.) extracted from the images into “intelligent” 3D geometry configuration data that can be imported into a 3D piping design tool to generate a 3D pipeline model that acts as a digital replica of the original (e.g., as-built) piping system (sometimes referred to herein as a “3D digital twin” of the piping system). The 3D piping design tool then can allow improved 3D visualization and manipulation of the piping model, e.g., revisions and modifications in the design of the piping system across multiple versions. The 3D geometry configuration data can be formatted or converted into a standard format such as a Piping Component File (PCF), which can facilitate communication of piping component information across different applications, platforms, and stakeholders. PCF is a standard (platform-agnostic) is a text file that contains the geometry and material information of all the pipes and piping components of a piping system.

For example, once transformed, the 3D geometry configuration data can be manipulated using advanced 3D piping management software such as, for example, and without limitation, the Intergraph SPOOLGEN® piping design tool, which is a proven, industrial-strength application that enables the creation of piping isometric drawings for fabrication and erection from the design created during the detail engineering phase of projects. The SPOOLGEN technology is based on ISOGEN®, the industry-standard software for automated piping isometric generation that has been deployed successfully on all sizes of plant engineering projects in every region of the world. Of course, by producing 3D geometry configuration data in a standard format such as PCF, the 3D geometry configuration data also can act as a digital footprint that can be shared across multiple stakeholders to help in different processes like piping design, fabrication, work estimation, spooling, construction, inspection, correlation, modification, transportation, etc. There currently are more than 20 major 3D design systems that will accept PCF as an input feed and generate the 3D piping model, making this innovation more robust across the plant industry. It is envisioned that certain aspects described herein may be implemented within or in conjunction with SPOOLGEN and/or ISOGEN although it should be noted that embodiments may be implemented with other tools and software (e.g., Smart 3D, E3D, etc.).

Overall, embodiments are expected to improve productivity (e.g., by avoiding the arduous task of manually transforming 2D isometric images into intelligent 3D geometric configuration data) and improve quality (e.g., by reducing human errors that can occur through manual processing) while also saving significant resources such as capital and energy. 3D digital drawings that are generated from the paper isometric images will offer greater accuracy, productivity, collaboration, visualization, and cost savings compared to the original paper isometric images and will contribute to a more efficient and streamlined design process, resulting in well-executed and optimized plant designs. Also, automated creation of piping systems in the model that match to the physical facility will give an opportunity for users to auto-tag and correlate with PIDs.

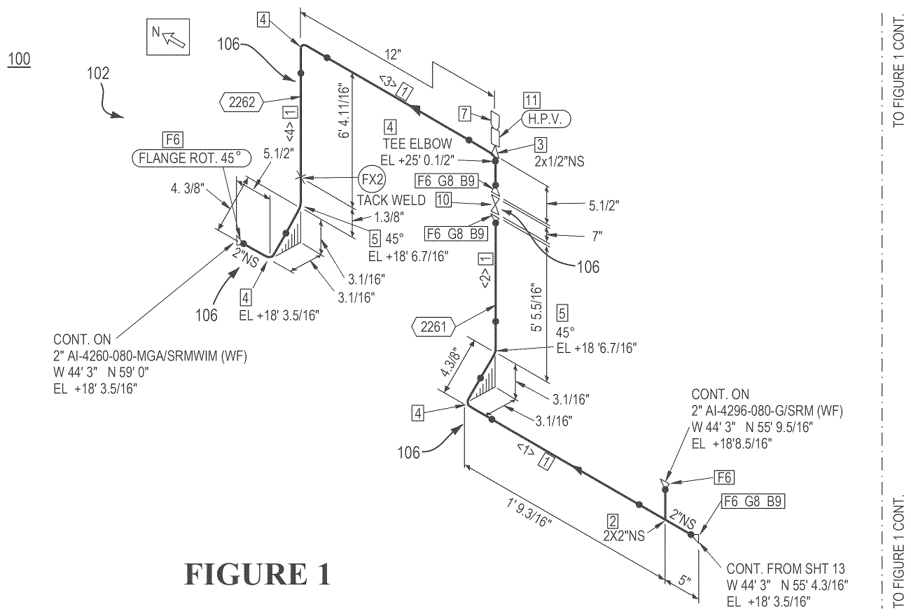

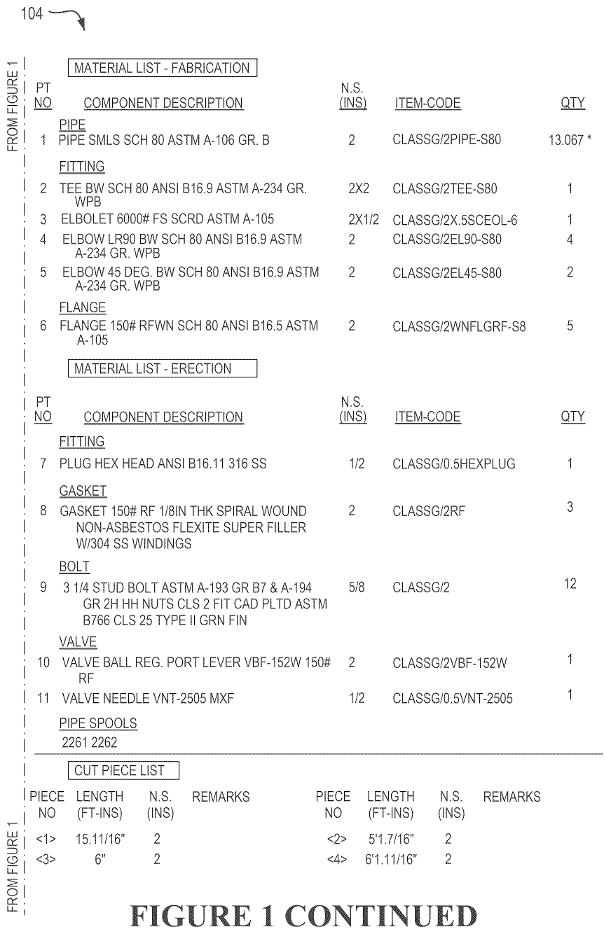

FIG. 1 illustrates an exemplary isometric image 100 (interchangeably referred to as “the image 100”), according to an embodiment of the present disclosure. The isometric image 100 may include a 2-Dimensional (2D) isometric drawing 102 (hereinafter referred to as “the drawing 102”) of a piping structure and a material list 104. The drawing 102 and the material list 104 may be separated by a predefined distance in the width of the image 100.

The drawing 102 may represent a 3-Dimensional (3D) view of the piping structure on a 2-D surface/plane. The drawing 102 may include various piping components 106 such as, but not limited to, pipes, fittings, valves, flanges, pumps, and other equipment. In some embodiments, the piping components 106 may be represented in an actual size and shape within the isometric view. In some other embodiments, the piping components 106 may be represented in a scaled size and shape within the isometric view. In an exemplary embodiment, the drawing 102 may also include a plurality of arrow components and corresponding text data related to the piping components 106. The text data corresponding to the piping components 106 may include information such as, but not limited to, dimensions, scale, and a title/name of the corresponding piping component. The dimensions may correspond to essential information about the piping structure, including pipe sizes, lengths, diameters, angles, and distances between the piping components 106. Specifically, the dimensions help ensure accurate construction and installation of the piping structure. Further, the scale may define a relation of each unit of measurement on the drawing 102 with a specific unit of measurement in a real-world piping structure. Examples of common scales may include, but not limited to, 1:1, 1:2, or 1:5, depending on the level of details which are required to construct and install the piping structure.

The drawing 102 may be drawn with various types of lines such as solid lines, dotted lines, hidden lines, and the like, to represent different piping components of the piping structure. The drawing 102 may also include a title block (not shown) which may include information such as, but not limited to, drawing title, date, project name, scale, etc.

The material list 104 may include material-related information corresponding to the piping components 106. For instance, the material list 104 may include information such as component/part number, component description, component/item code, and material quantity.

In some embodiments, a user may use the component description and the item code information of the material list 104 to map with a predefined configuration database to install or construct the piping structure.

In an exemplary embodiment, the material list 104 may be defined as a list of material, components, and fittings required for the piping structure depicted in the drawing 102. The material list may act as a crucial reference for procurement, construction, and maintenance activities corresponding to the piping structure. In one embodiment, the material list 104 may also include insulation information such as, a type of insulation material, a thickness of insulation material, and the like. In an exemplary embodiment, the material list 104 may include drawing reference including reference numerals used in the drawing 102 to cross-reference the materials included in the material list 104. The material list 104 may be defined in a clear and systematic manner to facilitate easy access to the information included in the material list 104 and maintain an integrity and safety of the piping structure.

Thus, the isometric image 100 enables easy and safe installation and/or construction of the corresponding piping structure.

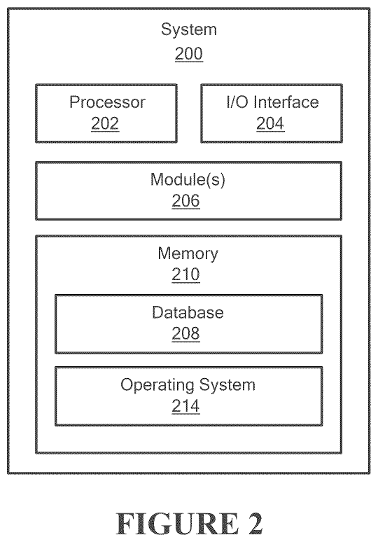

FIG. 2 illustrates a system 200 for generating digital piping data from a paper isometric image, according to an embodiment of the present disclosure. The system 200 may be included within, but is not limited to, one or more devices such as a server, a computer, a personal computing device, a user equipment, a laptop, a tablet, a mobile computing/communication device (e.g., a smartphone, a wearable device such as a smart watch, etc.), and so forth. Further, the system 200 may include one or more processors 202 (hereafter referred to as “the processor 202”), an Input/Output (I/O) interface 204, a plurality of modules 206, a transceiver 208, and at least one memory 210 (hereafter referred to as “the memory 210) communicably to each other. The processor 202 may include one or more cloud-based processors.

The processor 202 may include specialized processing units such as, but not limited to, integrated system (bus) controllers, memory management control units, floating point units, digital signal processing units, etc. In one embodiment, the processor 202 may include a Central Processing Unit (CPU), a Graphics Processing Unit (GPU), or both. The processor 202 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor 202 may execute a software program, such as code generated manually (i.e., programmed) to perform the desired operation.

In an embodiment, the processor 202 may be configured to receive the 2-Dimensional (2D) isometric image 100 corresponding to a piping structure. The 2D isometric image 100 may include the one or more piping components 106 corresponding to the piping structure. Further, the 2D isometric image 100 may include a plurality of arrow components and corresponding text data related to the one or more piping components 106. The processor 202 may further be configured to identify various characteristics such as, but not limited to, a direction, an orientation, a name, and dimensions, of each of the one or more piping components 106 in a 3D space based on the plurality of arrow components and corresponding text data included in the 2D isometric image 100. In some embodiments, the processor 202 may be configured to identify one or more welds/joints in the piping structure. Further, the processor 202 may identify the piping components 106 associated with the identified one or more welds/joints. Moreover, the processor 202 may identify the direction, the orientation, the name, and the dimensions of each of the piping components 106 based on the identified one or more welds/joints, the plurality of arrow components, and the corresponding text data.

In an embodiment, the text data may include the material list 104 as illustrated in FIG. 1. The processor 202 may also be configured to identify 3D coordinate information corresponding to a start point and an end point of each of the one or more piping components 106 based on the identified corresponding characteristics of the piping component 106. Thereafter, the processor 202 may be configured to generate 3D geometry configuration data corresponding to each of the one or more components 106 of the piping structure based on the corresponding identified 3D coordinate information, and the corresponding characteristics, in a predefined standard format. In some embodiment, the processor 202 may be configured to identify the 3-Dimensional (3D) coordinate information using one or more predefined techniques, such as, but not limited to, Optical Character Recognition (OCR), template matching, and deep learning. In some embodiments, the processor 202 may be configured to apply a predefined color to each of the one or more piping components 106 of the piping structure based on at least one of the identified direction and the orientation of the corresponding piping component 106. The processor 202 may arrange the one or more piping components 106 in a North arrow direction in the 3D space based on the applied predefined color and a prestored color-code directional scheme. Further, the processor 202 may be configured to generate the 3D geometry configuration data based on the arrangement of the one or more piping components 106 in the North arrow direction in the 3D space. The 3D geometry configuration data may include, but is not limited to, geometry-related information and material-related information corresponding to the one or more piping components 106 of the piping structure.

The processor 202 may further be configured to generate a 3D piping structure corresponding to the piping structure of the 2D isometric drawing based on the generated 3D geometry configuration data corresponding to each of the one or more components 106 of the piping structure. The 3D piping structure comprises one or more customizable piping components corresponding to the one or more piping components 106 of the piping structure. The customizable piping components may correspond to the 3D graphical representation of the corresponding piping components.

The processor 202 may be disposed in communication with one or more input/output (I/O) devices via one or more I/O interfaces 204 (hereafter referred to as “the I/O interface 204”). The I/O interface 204 may employ communication techniques such as, Code-Division Multiple Access (CDMA), High-Speed Packet Access (HSPA+), Global System for Mobile communications (GSM), Long-Term Evolution (LTE), WiMax, WiFi, Bluetooth, or the like, etc.

Using the I/O interface 204, the system 200 may communicate with one or more I/O devices. For example, the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), Plasma Display Panel (PDP), Organic Light-Emitting Diode display (OLED) or the like), audio speaker, etc.

The processor/controller 202 may be disposed in communication with a communication network via a network interface. In an embodiment, the network interface may be the I/O interface 204. The network interface may connect to the communication network to enable connection of the system 200 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area network (LAN), Wide Area Network (WAN), wireless network (e.g., using Wireless Application Protocol), the internet, etc.

The plurality of modules 206, amongst other things, include routines, programs, objects, components, data structures, etc., which perform particular tasks or implement data types. The plurality of modules 206 may also be implemented as, signal processor(s), state machine(s), logic circuitries, and/or any other device or component that manipulate signals based on operational instructions.

Further, the plurality of modules 206 may be implemented in hardware, instructions executed by at least one processing unit, for e.g., the processor 202, or by a combination thereof. The processing unit may comprise a computer, a processor, a state machine, a logic array and/or any other suitable devices capable of processing instructions. The processing unit may be a general-purpose processor which executes instructions to cause the general-purpose processor to perform operations or, the processing unit may be dedicated to performing the required functions. In some example embodiments, the plurality of modules 206 may be machine-readable instructions (software, such as web-application, mobile application, program, etc.) which, when executed by the processor/processing unit, perform any of the described functionalities.

In an implementation, the plurality of modules 206 may include a receiving module, an identifying module, and a generating module, configured to perform one or more operations of the processor 202. The processor 202 may be communicably coupled to the plurality of the modules 206 to perform the operations, as discussed herein.

In an embodiment of the present disclosure, the plurality of modules 206 may be implemented as part of the processor 202. In another embodiment of the present disclosure, the plurality of modules 206 may be external to the processor 202. In yet another embodiment of the present disclosure, the plurality of modules 206 may be part of the memory 210. In another embodiment of the present disclosure, the plurality of modules 206 may be part of hardware, separate from the processor 202 and/or the memory 210.

The memory 210 may be configured to store data, and instructions executable by the processor 202. In one embodiment, the memory 210 may communicate via a bus within the system 200. The memory 210 may include any non-transitory computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROM (EPROM), flash memories, hard disks, optical disks, and magnetic tapes. In one example, the memory 210 may include a cache or random-access memory for the processor 202. In alternative examples, the memory 210 is separate from the processor 202, such as a cache memory of a processor, the system memory, or other memory. The memory 210 may be an external storage device or a database 208 for storing data. The functions, acts or tasks illustrated in the figures or described may be performed by the programmed processor 202 by executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like. Further, the memory 210 may include an operating system 214 for performing one or more tasks of the system 200, as performed by a generic operating system in the computing domain.

Further, it is contemplated that embodiments may include a tangible, non-transitory computer-readable medium that includes instructions or receives and executes instructions responsive to a propagated signal. Further, the instructions may be transmitted or received over the network via a communication port or interface or using a bus (not shown). The communication port or interface may be a part of the processor 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the system 200 may be physical or may be established wirelessly. The network may alternatively be directly connected to the bus. For the sake of brevity, the architecture, and standard operations of the processor 202, the one or more modules 206, and the memory 210 are not discussed in detail.

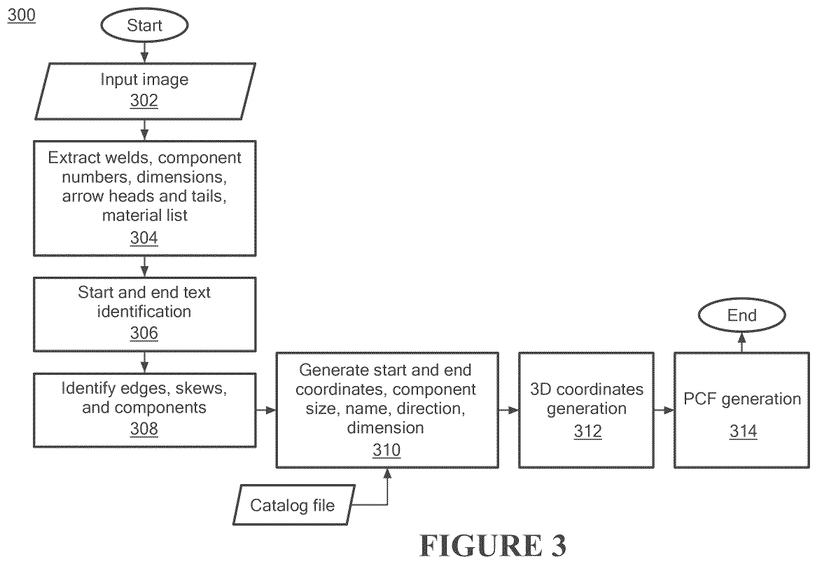

FIG. 3 illustrates a process flow depicting a method 300 for generating the piping data from the paper isometric image, according to embodiments of the present disclosure. The method 300 may be implemented by the one or more components of the system 200, as shown in FIG. 2. For instance, the steps of the method 300 may be performed by the processor 202 and/or the one or more modules 206.

The method 300 initiates at step 302, where a paper isometric image is received as an input, e.g., in a conventional Computer-Aided Design (CAD) or Portable Document Format (PDF) formats. If the paper isometric image is not already in a digital form (e.g., actually on paper), a digital version of the paper isometric image may be generated, e.g., using a digital scanner, digital camera, etc. In one embodiment, the paper isometric image corresponds to the isometric image 100, as shown in FIG. 1. Specifically, at step 302, the processor 202 may receive the paper isometric image 100 as the input.

At step 304, the processor 202 may be configured to extract information such as, but not limited to, welds, component numbers, component name, dimensions, arrow heads and tails, and material list. The material list may correspond to the material list 104, as shown in FIG. 1. Further, the welds may correspond to joints illustrating a connecting points of two or more components. In one embodiment, the paper isometric image may include specific symbols and annotations to indicate locations where two or more pipes or piping components are joined together using welding techniques. Such symbols and annotations may be referred as the welds. In some embodiments, the welds may be represented by specific graphical symbols that provide information about a type of weld, a size of weld, and other essential information corresponding to the weld. Examples of welds may include, but not limited to, fillet welds, groove welds, plug welds, and so forth. Further, the component numbers may be used to identify and label various piping components, such as pipes, valves, fittings, and other elements. The component numbers serves as a reference system to help a user easily identify and locate specific components within the piping structure. Specifically, the component numbers are unique identifiers assigned to each piping component in the piping structure. The dimension may be defined as numerical values and graphical representations used to define a size, a length, and spatial relationships of various piping components within the piping structure. The arrow heads and tails may be defined as graphical symbols used to indicate a direction of flow of fluid or an orientation of a piping component in the piping structure.

At step 306, the processor 202 may perform a start and an end text identification. Specifically, the processor 202 may identify 3D coordinate information corresponding to a start point and an end point of each of the one or more piping components 106 based on the identified corresponding information, such as, but is not limited to, the direction, the orientation, the component name, and the dimensions.

At step 308, the processor 202 may identify edges, skews, and components in the piping structure. In one embodiment, the edges may represent visible lines that correspond to the pipes, fittings, and other piping components. The edges may define a geometry and a layout of the piping structure in the 3D space. The skews may represent angular displacement of the piping components in an isometric drawings 102 from an actual horizontal or vertical position. In one embodiment, the processor 202 may be configured to de-noise the image of piping structure before identifying the edges. Further, the processor 202 may be configured to use any suitable edge identification technique such as, but not limited to, canny edge technique, to identify the edges of the piping structure.

Next, at step 310, the processor 202 may utilize a catalogue file to generate 2D coordinate information corresponding to the start point and the end point of each of the one or more piping components 106 based on the identified 3D coordinate information, the start and the end text, and/or the identified edges, and skews information. The catalogue file may be defined as a digital or electronic database or document that includes information about piping components and materials that are generally used in the piping systems/structures.

Next, at step 312, the processor 202 may generate the 3D coordinates information corresponding to the piping components 106 based on generated 2D coordinate information corresponding to the start point and the end point of each of the one or more piping components 106.

At step 314, the processor 202 may be configured to generate the 3D geometry configuration data corresponding to each of the one or more components 106 of the piping structure based on the corresponding identified 3D coordinate information. The generated 3D geometry configuration data may be stored in a file which is referred to as a Piping Component File (PCF). The PCF may be a text document that includes the 3D geometry configuration data corresponding to each of the one or more components 106 of the piping structure, e.g., the end points, outside diameter, center point, branch point, angle, material, piping specification, identifier, item code, and/or other relevant characteristics of each component, together with other information required for a PCF (e.g., units for such things as bore, bolt lengths, bolt diameters, weight, etc.). Thus, certain embodiments essentially translate a paper isometric image into a PCF, which can be extremely useful because PCF is an industry standard for representing pipelines and piping components that is widely used in fields such as piping design, engineering, procurement, construction, fabrication, transportation, testing, etc. In such embodiments, the processor 202 generally would be configured with the logic needed to generate PCFs from the data it derives from one or more paper isometric images, which, for example, could include the use of predefined templates for each type of component (e.g., pipes, flanges, tees, gaskets, elbows, etc.) and for the overall PCF and could be extended to any kind of plant customer with their unique symbology for piping components and operate with variety of CAD/PDF drawing types.

Embodiments are exemplary, and the steps of method 300 may be performed with any suitable variation such as, with an addition of one or more steps.

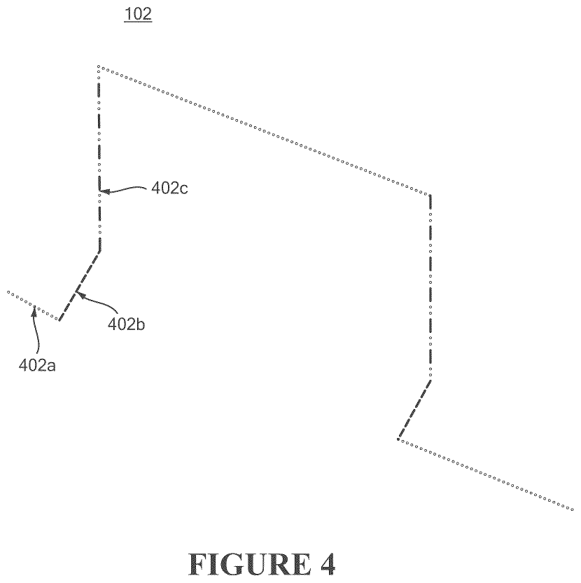

FIG. 4 illustrates different line forms in the isometric drawing 102, according to an embodiment of the present disclosure. Specially, FIG. 4 illustrates that different type lines may be used to represent different piping components 402a-402c of the piping structure, e.g., in a rendering of the 3D geometry configuration data in a graphical user interface or other display. The different piping components 402a-402c may correspond to the one or more piping components 106. While for illustration, different types of dotted lines have been used here to differentiate the piping components 106, various other means such as, but is not limited to, different color scheme, may be used to differentiate the various piping components (e.g., with piping component 402a rendered in blue, piping component 402b rendered in sea blue (aqua), piping component 402c rendered in green, etc. In some embodiments, the processor 202 may differentiate the various piping components 106 based at least on such things as the types of piping components, axes of the piping components, orientation of the piping components, and/or other characteristics. The use of different colors, line types, or other visual differentiators to represent different piping component characteristics can be particularly useful in allowing users to visually identify and understand the various piping components. Graphical user interfaces also can allow users to obtain information about the piping components in other ways, e.g., allowing users to click on, hover over, or otherwise select a particular piping component in the rendering to obtain information about that piping component (e.g., in a pop-up box or separate window).

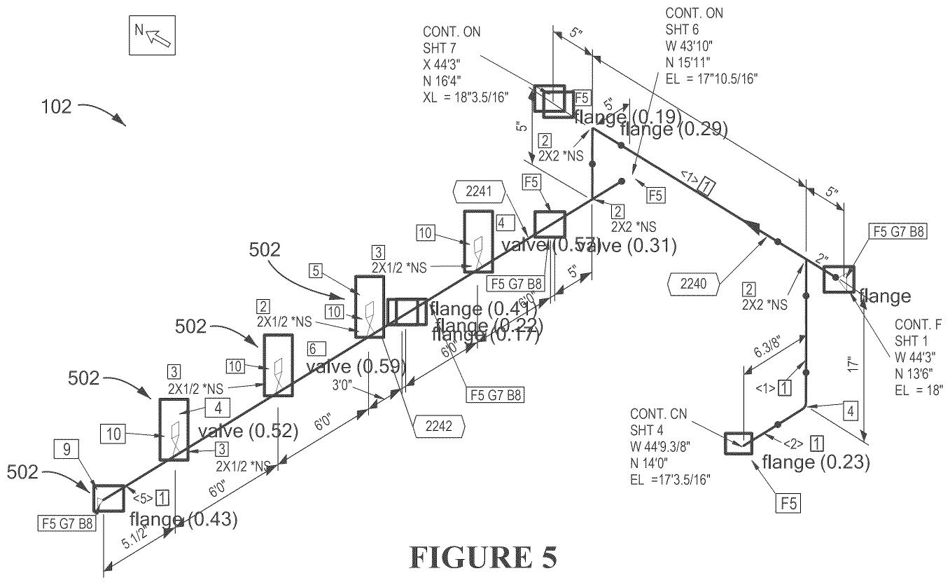

FIG. 5 illustrates symbol identification in the isometric drawing 102, according to an embodiment of the present disclosure. The processor 202 may be configured to identify various symbols 502 used in the isometric drawings 102. The processor 202 may use any of various types of Artificial Intelligence (AI) or Machine Learning (ML techniques) to identify the symbols 502. Such AI/ML techniques may include, but not limited to, Deep Learning (DL), Optical Character Recognition (OCR), and so forth. Such AI/ML techniques generally involve training an AI/ML model using actual and/or simulated paper isometric images (e.g., annotated to assist with the training of the AI/ML model for such things as identifying components and performing mathematical operations for producing 3D data from the 2D images) with optional human expert feedback to help further train or re-train the AI/ML model. Further, the processor 202 may perform various image processing techniques to identify the symbols 502. Such image processing techniques may include, but not limited to, noise reduction, masking techniques, edge detection, contour detection, and template matching. Specifically, the symbols and/or corresponding annotations may be used to convey essential information about the components, connections, and features of the piping structure. The symbols assist the user in understanding the layout and functions of the piping structure. For example, lines typically represent pipes, an arrow at an end of a line may indicate a direction of fluid in the pipe, a 90-degree elbow symbol may represent a 90-degree turn, different valve symbols may be used to represent valves in the piping structure, and two flat circles with bolt holes and a line connecting them to the pipe may represent a flange. Similarly, other symbols may be used to represent and distinguish different components of the piping structure. In some embodiments, lines of different thicknesses and different arrow heads may be used to represent different information, for instance, a line with a thicker arrowhead may be used to represent the direction of fluid in the pipe. Similarly, the dimension lines, the line used for component numbers may have different arrow heads, as shown in the drawing 102. Moreover, in some embodiments, the piping components such as, bolts and gaskets may be represented as annotations with no graphics using alphanumeric tag at the flange graphics which is mapped to material report 104. For example, a tag F2 may be used to represent a flange, a tag G3 may be used to represent a gasket, and a tag B4 may be used to represent a bolt. The processor 202 may identify these symbols to accurately identify the corresponding piping component.

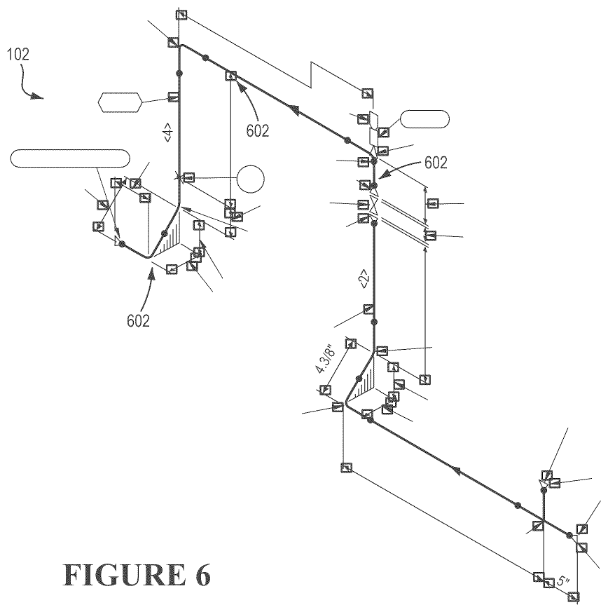

FIG. 6 illustrates arrowhead identification in the isometric drawing 102, according to an embodiment of the present disclosure. The processor 202 may be configured to remove text information from the isometric drawing 102 and identify arrowheads 602 in the isometric drawing 102. In one non-limiting embodiment, the processor 202 may use a template matching technique to identify the various arrowheads 602 in the isometric drawing 102. The arrowheads 602 may serve as a visual identification to understand the flow direction of liquids or gases through the pipes and/or the piping components of the piping structure. Further, the template matching technique may be defined as a computer vision and image processing technique that involves identifying instances of a specific template or a pattern within a larger image as identified from the isometric drawing 102. Specifically, the template matching technique may be used to locate and identify specific piping components, symbols, or features within the isometric drawing 102.

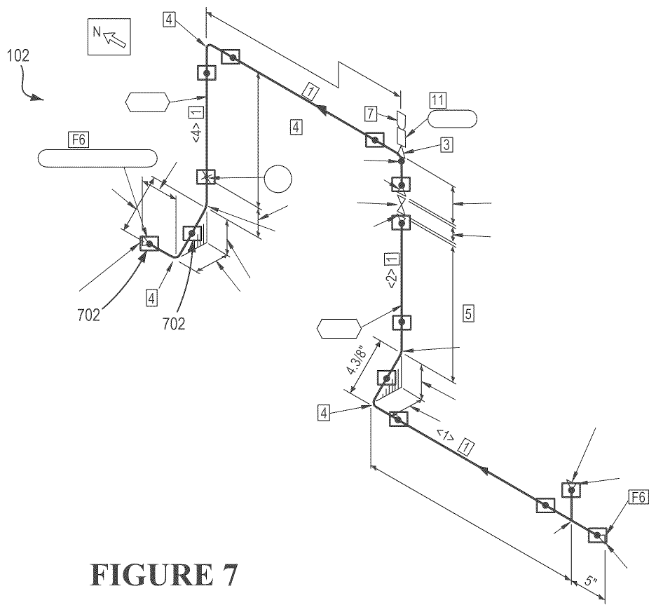

FIG. 7 illustrates weld identification in the isometric drawing 102, according to an embodiment of the present disclosure. Specifically, the processor 202 may be configured to identify welds 702 in the isometric drawing 102 to locate and identify the one or more piping components 106 of the piping structure. In one non-limiting embodiment, the processor 202 may use a template matching technique to identify the welds 702 in the isometric drawing 102. The welds 702 may be represented using specific symbols and annotations to indicate where two sections of pipes or other piping components are joined together by a welding process. In one embodiment, the welds 702 may be represented using simple round dark dots on the piping structure. However, embodiments either cover or intend to cover any suitable symbol for the welds 702 which defines the information regarding welding types, welding procedure, and specifications. In a non-limiting example, the welding types may include workshop welds, and site welds. Further, different welding symbols may be used to represent different types of welding. For instance, in the illustrated embodiment, dark dots have been used to represent the workshop welds and dark dots with cross have been used to represent the site welds. The processor 202 may identify the welds 702 to determine the number of piping components corresponding to the piping structure illustrated by the isometric drawing 102. In some embodiments, the welds 702 may be represented by weld symbols. The weld symbol may be used to indicate the location of a weld joint. The weld symbol may include, but not limited to, a simple geometric shape, usually a triangle, with one or more lines and arrows extending from the shape. In some other embodiments, the weld symbols may also include abbreviations representing the type of welding used to connect the corresponding piping components. Further, the weld symbols may define information regarding the welding procedure and specifications, such as the welding rod type, size, and other essential information.

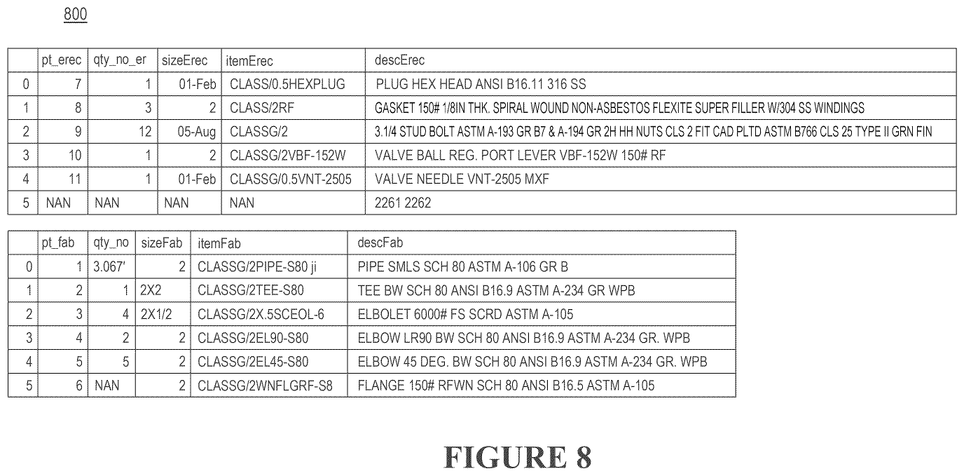

FIG. 8 illustrates erection and fabrication data 800 generated from the material list 104, according to an embodiment of the present disclosure. The data frames 800 may include information such as, but not limited to, quality of the piping components, size of the piping components, description of the piping components, erection type of the piping components, fabrication type of the piping components, and so forth. In one embodiment, the erection data may include information such as, but not limited to, layout and placement information, alignment and tolerance information, support information, join information, connection information, and safety consideration corresponding to the piping components of the piping structure. The fabrication data may include information such as, but not limited to, component specifications, cutting and bending information, welding information, component details, assembly instructions, and identification information corresponding to the piping components of the piping structure. The processor 202 may use the erection and fabrication data 800 to generate the 3D geometry configuration data and/or the PCF for the isometric image 100. Specifically, in an embodiment, the processor 202 may be configured to use the erection and fabrication data 800 to map the piping components identified in the drawing according to the part number mentioned in both the data frames. Further, the fabrication data frames may include information related to fabrication of piping components used in the piping structure at a workshop, and the erection data frames may include information related to erection/installation of the piping components on an installation site.

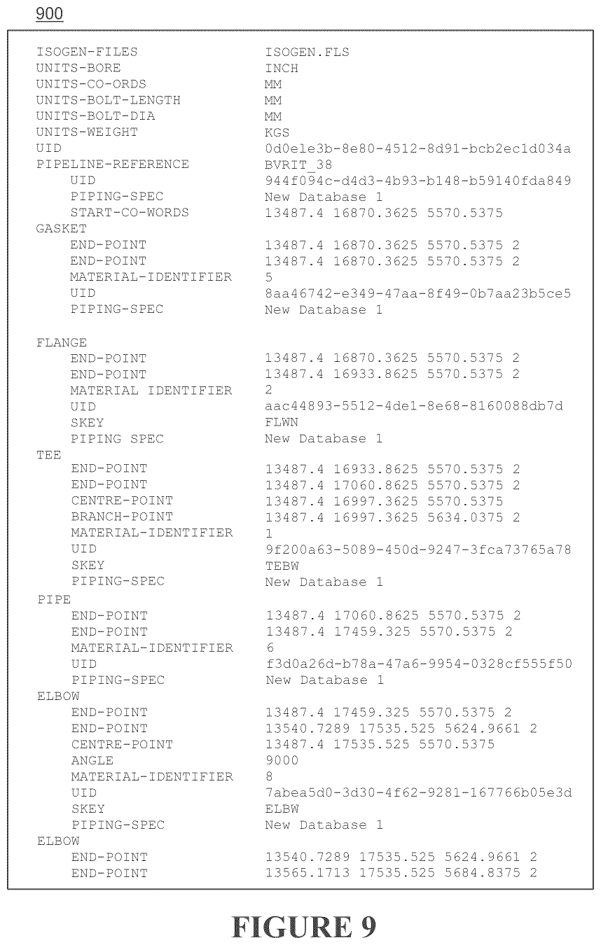

FIG. 9 illustrates an exemplary Piping Component File (PCF) 900, according to an embodiment of the present disclosure. The PCF 900 may include the 3D geometry configuration data corresponding to each of the one or more piping components of the piping structure, as generated by the processor 202. In an exemplary embodiment, a format of the PCF 900 may correspond to the predefined standard format. The PCF 900 may include information such as, but not limited to, measurement scale, measurement units, measurements corresponding to the piping components, reference values corresponding to the piping components, the start point and the end point of each of the piping components, a component identifier, a material identifier, a specification reference, and forth. The PCF 900 may be stored in the memory 210.

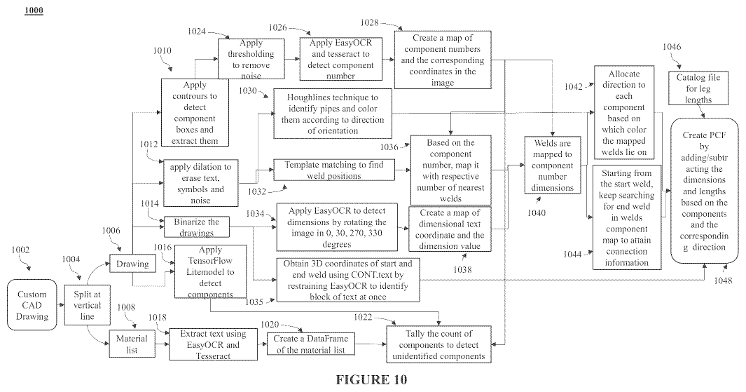

FIG. 10 illustrates a detailed process flow depicting a method 1000 for generating the piping data from the paper isometric image, according to embodiments of the present disclosure. The method 1000 may be performed by the processor 202 and/or the one or more modules 206.

At step 1002, the processor 202 may receive a paper isometric image such as a custom Computer-Aided Design (CAD) drawing, as input. In one embodiment, the CAD drawing may correspond to the isometric image 100, as shown in FIG. 1.

In this example, the CAD drawing includes a drawing image 102 and a material list 104 separated by a vertical line, for example, as shown in FIG. 1. Therefore, at step 1004, the processor 202 may split the CAD drawing based on the vertical line included in the CAD drawing. In certain other embodiments, material information may be included in other ways, e.g., in a box such as at the bottom righthand corner of the CAD drawing, in a material list that is separated from the drawing image by a horizontal line, in a material list that is not separated from the drawing image by one or more lines, in text that is not organized in a list or box, or in other ways. Such embodiments may extract material information in ways other than, or in addition to, splitting the drawing based on a line or box (e.g., by setting a distance threshold in the width of the image). In certain other embodiments, Step 1002 may be omitted, for example if the CAD drawing does not contain a material list.

At step 1006, the processor 202 may include obtaining the drawing image from the CAD drawing for further processing.

At step 1010, the processor 202 may apply contours to detect component boxes corresponding to one or more piping components 106 corresponding to a piping structure represented in the drawing image. Specifically, the processor 202 may extract the detected component boxes and process the component boxes using techniques such as, but not limited to, optical character recognition (e.g., Easy OCR or Pytesseract), to recognize the component number text from the component boxes, as shown by step 1026. Further, the processor 202 may the store a mapping of component number to corresponding component box centroid in the memory 210, as shown by step 1028. Prior to step 1026, at step 1024, the processor 202 may apply a thresholding technique to remove the noise from the drawing.

At step 1012, the processor 202 may apply a dilation technique to erase text, symbols, and noise from the drawing image. Specifically, the processor 202 may apply the dilation technique to highlight graphics corresponding to the one or more piping components and to remove high-frequency elements like text, arrows, and components like olets and valves.

At step 1030, the processor 202 may apply Hough lines technique on the dilated drawing to identify the line segments corresponding to a pipeline in the drawing. In one embodiment, the processor 202 may calculate the angle of orientation of the identified line segments and assign a color for case of representation. For example, the processor 202 may assign blue color to the North-South axis, a red color to the East-West axis, and a green color to an elevation axis. Further, the processor 202 may assign a sea blue color to skews, i.e., line segments that do not fall in any of the above categories. In some embodiments, the processor 202 may use different techniques to differentiate the axes, for example, different types of dotted lines to represent different axes, as shown in FIG. 4. Further, at step 1032, the processor 202 may perform template matching on the dilated drawing to identify the welds and corresponding positions. Specifically, the processor 202 may apply OCR and remove all the identified text to obtain the dilated drawing with no text (e.g., to avoid confusion of textual information from piping information, e.g., inch marks in dimensions being confused for welds). Therefore, to avoid such an error, the processor 202 may perform the template matching on the dilated drawing. The processor 202 may be configured to store centroids (x, y) of all identified weld symbols in a list container and/or the memory 210. The processor 202 may be configured to classify the identified welds based on the corresponding axis, e.g., using the color-coding techniques, as discussed above. Further, the processor 202 may remove the centroids from the drawings.

At step 1014, the processor 202 may binarize the drawing, i.e., convert the drawing into a bi-level document image. Specifically, the processor 202 may be configured to separate image pixels of the drawing into dual collection of pixels, i.e., black, and white. The processor 202 may be configured to binarize the drawing by defining a threshold and changing the pixel value to either 0 or 1 based on a comparison with the defined threshold. At step 1034, the processor 202 may perform OCR to detect and store the dimensions of the one or more piping components 106, e.g., by rotating the drawing in various angles and/or orientations (e.g., 30, 270, 330, and 0 degrees) and passing the rotated drawing to OCR to identify dimensions written in several different orientations (where regular expressions may be used to validate dimension patterns such as m, mm, ft, in, etc.). At step 1035, the processor 202 may obtain 3D coordinates of a start and an end position of the welds and/or the piping components. In an embodiment, the processor 202 may obtain the 3D coordinates of the start and the end position of the piping components from a document named as “CONT.text”. The document “CONT.text” may explain that the current drawing is in continuation from another sheet or drawing. This enables the processor 202 to effectively identify/compose the whole piping structure that is defined in multiple sheets. The processor 202 may obtain the 3D coordinates of the start and the end position (e.g., 3D coordinates) of the welds and/or the piping components using techniques such as, for example, deep learning or OCR. The processor 202 may map and store the start and the end position of the welds to the nearest 2D weld centroid. Further, the processor 202 may remove the 3D coordinates from the drawing. Specifically, the processor 202 may use the template matching technique on the no text drawing to identify arrow heads corresponding to the one or more piping components 106 by rotating the arrowhead template in 0.5 degree increments and store the detected arrowhead centroids in a list container and/or the memory 210.

Further, the processor 202 may be configured to remove all the pipeline segments by using a canny library and/or a threshold value of 200 and apply Hough lines to identify arrow tails. The processor 202 may maintain a map of the arrows such as, a line end point and a line start point corresponding to the one or more piping components 106. Further, the processor 202 may store the map as an arrow tails point map in the memory 210.

Moreover, the processor 202 may be configured to define a distance threshold to map the identified arrow heads to the arrow tails. The processor 202 may be configured to iterate for each arrowhead centroid and search for the nearest tail in the points map. Further, the processor 202 may differentiate different arrows based on corresponding head and tail information. For instance, in case if the arrow tail gets mapped to only one arrowhead, it is deemed a single headed arrow. In one embodiment, the single headed arrows may be used for mapping component numbers with respective component weld. The processor 202 may be configured to identify the components numbers with respective component weld based on identified type of arrow. In another example, an arrow tail is mapped to 2 arrow heads, it is used for dimension mapping to the component. Thus, the processor 202 may identify the dimensions of the piping components.

At step 1008, the processor 202 may obtain the material list. In one embodiment, the material list may correspond to the material list 104, as shown in FIG. 1.

At step 1018, the processor 202 may extract the text information from the material list using techniques such as, but not limited to, optical character recognition (e.g., Easy OCR or Pytesseract). Next, at step 1020, the processor 202 may generate erection and fabrication data, similar to erection and fabrication data 800, as shown in FIG. 8. In some embodiments, the erection data and fabrication data may be separated by a horizontal line. Further, vertical lines may be drawn to separate the columns of the erection and fabrication data using header strings. In one embodiment, each column from both tables is passed to OCR to extract the text and fill it in a data frame. Next, the processor 202 may create respective component list containers, as per component type, obtained in the fabrication and erection data frames.

In one embodiment, at step 1016, the processor 202 may be configured to detect the piping components using techniques such as, but not limited to, TensorFlow Lite model. The TensorFlow lite model may be defined as a Deep Learning (DL) method, which may be used for object detection in an image. Therefore, the processor 202 may use the TensorFlow Lite model to detect the respective piping components. Using the TensorFlow lite model, the processor 202 may employ the proposed solution to portable devices such as, but not limited to, embedded devices, smartphone, tablets, and so forth.

At step 1022, the processor 202 may be configured to validate the number of identified components from steps 1016, 1028 and 1020. Specifically, at step 1022, the processor 202 may detect unidentified components of the piping structure.

Further, after step 1032, at step 1036, the processor 202 may map the one or more piping components with respect number of nearest welds, e.g., by tracing an arrowhead tail associated with a component to find the head corresponding to that component. The processor 202 may perform such mapping based on the identified number of piping components. Specifically, the processor 202 may identify the nearest welds corresponding to a piping component based on the type of components and the corresponding arrowhead. In case the processor 202 fails to identify the arrowhead, the end of the line segment corresponding to the piping component may be used to map the piping component to the welds. Further, in case the processor 202 also fails to identify the tail of the arrow corresponding to the piping component, the processor 202 may map the nearest welds for the component box. In an exemplary embodiment, based on mapping performed at step 1036, the processor 202 may generate an output as:

Map of Component number: tuple of welds corresponding to the component number (e.g., [2: ((x1, y1), (x2, y2)), ((x3, y3), (x4, y4))]).

Furthermore, after step 1034, at step 1038, the processor 202 may create a map of dimensional text coordinate and the dimension value. In an embodiment, the processor 202 may map the identified dimensions at step 1034 with the respective component welds, noting that dimensions may be written over parallel lines (double headed arrows) from the components. Further, the processor 202 may check centroid of each arrowhead with the nearest paid of welds. If the arrowheads are equidistant from the centroid, the processor 202 may map the identified dimension to that weld. In the case of Olets, the arrowhead/tail end may be mapped to the corresponding component box and the weld is used to assign a direction. The processor 202 may be configured to compute an orientation of the Olet by checking the slope between weld coordinates and the arrowhead coordinates. Further, in the case of skews, the underlying lines mentioned to indicate skew are identified and colored based on their orientation using Hough lines (and this orientation may be used to determine the axis in which the skew lies). In some embodiments, the processor 202 may be configured to generate a data frame with headers referring to Start (Weld Coords), End (Weld Coords), Branch (Weld Coords), Component Number, and Axis based on the above information. The skews in a piping isometric drawing may represent an angle by which the pipeline is oriented with respective axes. The skews may either be in 2D or 3D orientation. In general, a piping isometric drawing is an isometric view of an orthographic pipeline in a cartesian system. Therefore, the skew may provide the angle at which the pipeline is oriented with respect to the other axes. A 2D skew means that the pipeline is oriented at an angle with one axis and oriented in a 2D plane and a 3D skew represents the angle of orientation of the pipeline in 2 axes, which means in two 2D planes or a 3D plane. In case of skews, all the next components may be iterated until the next elevation/direction is obtained, and while traversing the components, dimensions may be added to find the hypotenuse of a skew triangle. The directional text may be subtracted from the current corresponding 3D coordinate to get the opposite side value of the skew triangle. Angle may be obtained by calculating the inverse sine. The sine and cosine values may be calculated and multiplied to the obtained hypotenuse and opposite values to generate the dimensions to be added in present 3D coordinates to generate the skew.

At step 1040, the processor 202 may map the identified welds with the respective piping components and corresponding dimension values.

At step 1042, the processor 202 may allocate a direction to each of the piping component. In an embodiment, the processor 202 may allocate the direction to each of the piping components based on assigned color of the corresponding welds (e.g., with respect to the axis in a data frame and by comparing the 2D vector orientation obtained from the welds).

At step 1044, the processor 202 may initiate a search from the starting point/position of the weld to the end point/position of the weld to obtain a complete connection information of the corresponding piping components.

At step 1048, the processor 202 may create the PCF (piping data) by adding/subtracting the dimensions and lengths based on the components and the corresponding direction, and information stored in a catalog file (as shown by 1046). Specifically, the processor 202 may obtain generic length of components from the catalog file based on the component number and other essential details to generate the PCF. For example, the catalog may be used to retrieve the lengths of the components like elbows, TEEs, flanges, valves, etc. In some embodiments, the processor 202 may also be configured to compute the 3D coordinates of the piping components (which can be mapped to the respective welds) to generate the PCF.

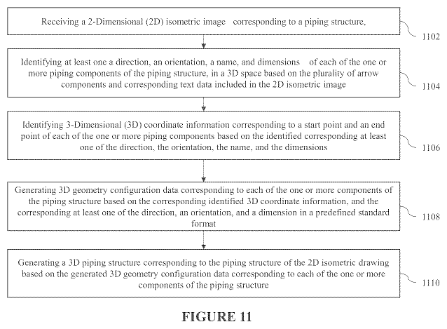

FIG. 11 illustrates a flow chart of a method 1100 for generating the digital piping data from the paper isometric image, according to embodiments of the present disclosure. The method 1100 may be performed by the processor 202 and/or the one or more modules 206.

At step 1102, the method 1100 includes receiving the 2-Dimensional (2D) isometric image 100 corresponding to a piping structure. The 2D isometric image 100 comprises one or more piping components 106 corresponding to the piping structure. The 2D isometric image 100 comprises a plurality of arrow components and corresponding text data related to the one or more piping components 106.

At step 1104, the method 1100 includes identifying at least one a direction, an orientation, a name, and dimensions of each of the one or more piping components 106 of the piping structure, in a 3D space based on the plurality of arrow components and corresponding text data included in the 2D isometric image 100.

At step 1106, the method 1100 includes identifying 3-Dimensional (3D) coordinate information corresponding to a start point and an end point of each of the one or more piping components based on the identified corresponding at least one of the direction, the orientation, the name, and the dimensions. The 3-Dimensional (3D) coordinate information may be identified using one or more predefined techniques comprises at least one of Optical Character Recognition (OCR), template matching, and deep learning.

At step 1108, the method 1100 includes generating 3D geometry configuration data corresponding to each of the one or more components of the piping structure based on the corresponding identified 3D coordinate information, and the corresponding at least one of the direction, an orientation, and a dimension in a predefined standard format. In one embodiment, the method 1110 includes applying a predefined color to each of the one or more piping components 106 of the piping structure based on at least one of the identified direction and the orientation of the corresponding piping component. Further, the method 1100 includes arranging the one or more piping components in a North arrow direction in the 3D space based on the applied predefined color and a prestored color-code directional scheme. Next, the method includes generating the 3D geometry configuration data based on the arrangement of the one or more piping components 106 in the North arrow direction in the 3D space. The 3D geometry configuration data comprises at least one of geometry-related information and material-related information corresponding the one or more piping components 106 of the piping structure.

At step 1110, the method 1100 includes generating a 3D piping structure corresponding to the piping structure of the 2D isometric drawing based on the generated 3D geometry configuration data corresponding to each of the one or more components of the piping structure.

The present disclosure therefore enables easy digitalization of paper isometric drawings. The present disclosure reduced human efforts and errors while digitalizing the paper isometric drawings. Specifically, the present disclosure provides an effective and efficient technique to digital the paper isometric drawings. The present disclosure generated the digitalized piping data which is supported by various applications and systems used for generating 3D piping data.

While specific language has been used to describe the disclosure, any limitations arising on account of the same are not intended. As would be apparent to a person in the art, various working modifications may be made to the method in order to implement the inventive concepts as taught herein.

The drawings and the forgoing description give examples of embodiments. Those skilled in the art will appreciate that one or more of the described elements may well be combined into a single functional element. Alternatively, certain elements may be split into multiple functional elements. Elements from one example may be added to another example. For example, orders of processes described herein may be changed and are not limited to the manner described herein.

Moreover, the actions (e.g., operations) of any flow diagram need not be implemented in the order shown; nor do all of the acts necessarily need to be performed. For example, actions or operations illustrated as being performed serially in two consecutive blocks may actually be performed concurrently, simultaneously, contemporaneously, or in some cases be performed in reverse order. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to challenges have been described above with regard to specific examples. However, the benefits, advantages, solutions to challenges, and any component(s) that may cause any benefit, advantage, or solution to occur or become more pronounced are not to be construed as a critical, required, or essential feature or component of any or all the claims.

What is claimed is:

1. A method of generating digital piping data from a paper isometric image, the method comprising;
receiving a 2-Dimensional (2D) isometric image corresponding to a piping structure, wherein the 2D isometric image comprises one or more piping components corresponding to the piping structure, and wherein the 2D isometric image comprises a plurality of arrow components and corresponding text data related to the one or more piping components;
identifying at least one of a direction, an orientation, a name, and dimensions of each of the one or more piping components of the piping structure, in a 3-Dimensional (3D) space, based on the plurality of arrow components and corresponding text data included in the 2D isometric image;
identifying 3D coordinate information corresponding to a start point and an end point of each of the one or more piping components based on the identified corresponding at least one of the direction, the orientation, the name, and the dimensions; and
generating 3D geometry configuration data corresponding to each of the one or more piping components of the piping structure based on the corresponding identified 3D coordinate information, and the corresponding at least one of the direction, an orientation, and a dimension in a predefined standard format.

2. The method of claim 1, further comprising:
applying a predefined color to each of the one or more piping components of the piping structure based on at least one of the identified direction and the orientation of the corresponding piping component;
arranging the one or more piping components in a North arrow direction in the 3D space based on the applied predefined color and a prestored color-code directional scheme; and
generating the 3D geometry configuration data based on the arrangement of the one or more piping components in a North arrow direction in the 3D space.

3. The method of claim 1, further comprising:
generating a 3D piping structure corresponding to the piping structure of the 2D isometric drawing based on the generated 3D geometry configuration data corresponding to each of the one or more components of the piping structure, wherein the 3D piping structure comprises one or more customizable piping components corresponding to the one or more piping components of the piping structure.

4. The method of claim 1, wherein the 3D geometry configuration data comprises at least one of geometry-related information and material-related information corresponding the one or more piping components of the piping structure.

5. The method of claim 1, wherein the 3-Dimensional (3D) coordinate information is identified using one or more predefined techniques comprises at least one of Optical Character Recognition (OCR), template matching, and deep learning.

6. The method of claim 1, comprising:
identifying at least one weld in the piping structure; and
identifying two or more piping components based on the identified at least one weld.

7. The method of claim 1, wherein the predefined standard format is a Piping Component File (PCF).

8. A system for generating digital piping data from a paper isometric image, the system comprising:
at least one processor communicably coupled with at least one tangible computer-readable memory containing instructions which, when executed by the at least one processor, causes the at least one process to perform computer processes comprising:
receiving a 2-Dimensional (2D) paper isometric image corresponding to a piping structure, wherein the 2D isometric image comprises one or more piping components corresponding to the piping structure, and wherein the 2D isometric image comprises a plurality of arrow components and corresponding text data related to the one or more piping components;
identifying at least one of a direction, an orientation, a name, and dimensions of each of the one or more piping components of the piping structure, in a 3-Dimensional (3D) space, based on the plurality of arrow components and corresponding text data included in the 2D isometric image;
identifying 3D coordinate information corresponding to a start point and an end point of each of the one or more piping components based on the identified corresponding at least one of the direction, the orientation, the name, and the dimensions; and
generating 3D geometry configuration data corresponding to each of the one or more piping components of the piping structure based on the corresponding identified 3D coordinate information, and the corresponding at least one of the direction, an orientation, and a dimension in a predefined standard format.

9. The system of claim 8, wherein the computer processes further comprise:
applying a predefined color to each of the one or more piping components of the piping structure based on at least one of the identified direction and the orientation of the corresponding piping component;
arranging the one or more piping components in a North arrow direction in the 3D space based on the applied predefined color and a prestored color-code directional scheme; and
generating the 3D geometry configuration data based on the arrangement of the one or more piping components in a North arrow direction in the 3D space.

10. The system of claim 8, wherein the computer processes further comprise:
generating a 3D piping structure corresponding to the piping structure of the 2D isometric drawing based on the generated 3D geometry configuration data corresponding to each of the one or more components of the piping structure, wherein the 3D piping structure comprises one or more customizable piping components corresponding to the one or more piping components of the piping structure.

11. The system of claim 8, wherein the 3D geometry configuration data comprises at least one of geometry-related information and material-related information corresponding the one or more piping components of the piping structure.

12. The system of claim 8, wherein the 3-Dimensional (3D) coordinate information is identified using one or more predefined techniques comprises at least one of Optical Character Recognition (OCR), template matching, and deep learning.

13. The system of claim 8, wherein the computer processes further comprise:
identifying at least one weld in the piping structure; and
identifying two or more piping components based on the identified at least one weld.

14. The method of claim 8, wherein the predefined standard format is a Piping Component File (PCF).

15. A computer program product comprising at least one tangible non-transitory computer-readable medium having stored thereon computer-executable instructions which, when executed by at least one processor, cause the at least one processor to perform computer processes comprising:
receiving a 2-Dimensional (2D) isometric image corresponding to a piping structure, wherein the 2D isometric image comprises one or more piping components corresponding to the piping structure, and wherein the 2D isometric image comprises a plurality of arrow components and corresponding text data related to the one or more piping components;
identifying at least one of a direction, an orientation, a name, and dimensions of each of the one or more piping components of the piping structure, in a 3-Dimensional (3D) space, based on the plurality of arrow components and corresponding text data included in the 2D isometric image;
identifying 3D coordinate information corresponding to a start point and an end point of each of the one or more piping components based on the identified corresponding at least one of the direction, the orientation, the name, and the dimensions; and
generating 3D geometry configuration data corresponding to each of the one or more piping components of the piping structure based on the corresponding identified 3D coordinate information, and the corresponding at least one of the direction, an orientation, and a dimension in a predefined standard format.

16. The computer program product of claim 15, wherein the computer processes further comprise:
applying a predefined color to each of the one or more piping components of the piping structure based on at least one of the identified direction and the orientation of the corresponding piping component;
arranging the one or more piping components in a North arrow direction in the 3D space based on the applied predefined color and a prestored color-code directional scheme; and
generating the 3D geometry configuration data based on the arrangement of the one or more piping components in a North arrow direction in the 3D space.

17. The computer program product of claim 15, wherein the computer processes further comprise:
generating a 3D piping structure corresponding to the piping structure of the 2D isometric drawing based on the generated 3D geometry configuration data corresponding to each of the one or more components of the piping structure, wherein the 3D piping structure comprises one or more customizable piping components corresponding to the one or more piping components of the piping structure.

18. The computer program product of claim 15, wherein the 3D geometry configuration data comprises at least one of geometry-related information and material-related information corresponding the one or more piping components of the piping structure.

19. The computer program product of claim 15, wherein the 3-Dimensional (3D) coordinate information is identified using one or more predefined techniques comprises at least one of Optical Character Recognition (OCR), template matching, and deep learning.

20. The computer program product of claim 15, wherein the computer processes further comprise:
identifying at least one weld in the piping structure; and
identifying two or more piping components based on the identified at least one weld.

21. The computer program product of claim 15, wherein the predefined standard format is a Piping Component File (PCF).
